(19) United States
(12) Patent Application Publication
(10) Pub. No.: US 2013/0033171 A1
(43) Pub. Date: Feb. 7, 2013

(54) ORGANOMETALLIC COMPOUND AND ORGANIC ELECTROLUMINESCENCE DEVICE EMPLOYING THE SAME

(71) Applicants: Heh-Lung HUANG, New Taipei City (TW); Teng-Chih Chao, Pingjhen City (TW)

(72) Inventors: Heh-Lung HUANG, New Taipei City (TW); Teng-Chih Chao, Pingjhen City (TW)

(21) Appl. No.: 13/243,547

(22) Filed: Sep. 23, 2011

(30) Foreign Application Priority Data
Aug. 5, 2011 (TW) 100127913

(51) Int. Cl. H01J 1/63; C07F 15/00

(52) U.S. Cl. 313/504; 546/4

(57) ABSTRACT

Organometallic compounds and organic electroluminescence devices employing the same are provided. The organic compound has a chemical structure as represented below:

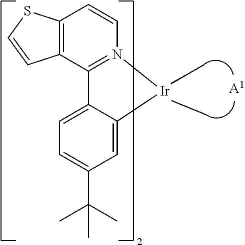

wherein, A¹ is diisopropyl carbodiimide ligand, 5-(2-pyridyl)-1,2,4-triazole ligand, acetylacetone with phenyl group ligand, 2-phenyl-1,3,4-oxadiazole ligand, or derivatives thereof. The organometallic compound of the disclosure can be applied in an organic electroluminescent device for enhancing the electroluminescent efficiency thereof.

### CROSS REFERENCE TO RELATED APPILCATIONS

This application is based upon and claims the benefit of priority from the prior Taiwan Patent Application No. 100127913, filed on Aug. 5, 2011, the entire contents of which are incorporated herein by reference.

### BACKGROUND

1. Field

The disclosure relates to an organometallic compound and organic electroluminescence device employing the same and, more particularly, to a phosphorescent organometallic compound and a phosphorescent organic electroluminescence device employing the same.

2. Description

Recently, with the development and wide application of electronic products, such as mobile phones, PDAs, and notebook computers, there has been increasing demand for flat display elements which consume less electric power and occupy less space. Organic electroluminescent devices are self-emitting and highly luminous, with wide viewing angles, fast response speeds, and simple fabrication methods, making them an industry display of choice.

Generally, an organic electroluminescent device is composed of a light-emission layer sandwiched between a pair of electrodes. When an electric field is applied to the electrodes, the cathode injects electrons into the light-emission layer and the anode injects holes into the light-emission layer. When the electrons recombine with the holes in the light-emission layer, excitons are formed. Recombination of the electron and hole results in light emission.

Depending on the spin states of the hole and electron, the exciton, which results from the recombination of the hole and electron, can have either a triplet or singlet spin state. Luminescence from a singlet exciton results in fluorescence whereas luminescence from a triplet exciton results in phosphorescence. The emissive efficiency of phosphorescence is three times that of fluorescence. Therefore, it is crucial to develop highly efficient phosphorescent material, in order to increase the emissive efficiency of an OLED.

An OLED is typically categorized into a micro-molecular and high-molecular OLED according to the substrate type thereof. A micro-molecular substrate OLED is generally fabricated by way of vacuum evaporation, such that the micro-molecular materials have a good film forming quality. However, 95% of the organic electroluminescent materials are deposited on the chamber wall of the manufacturing equipment used to manufacture the OLED, such that only 5% of the organic electroluminescent materials are coated on a substrate after the manufacturing process, resulting in a high investment cost.

Therefore, a wet process (such as spin coating or blade coating) has been provided to fabricate micro-molecular OLEDs to improve the utilization ratio of organic electroluminescent materials and reduce the cost of manufacturing OLEDs. Unfortunately, conventional phosphorescent organic electroluminescent materials are not suitable to be used in the wet process due to the inferior solubility thereof. Therefore, it is necessary to develop novel phosphorescent organic compounds (especially for reddish orange or red dopants) suitable for use in a wet process to fabricate phosphorescent OLEDs to solve the above problems.

### BRIEF SUMMARY

An exemplary embodiment of an organometallic compound has a Formula (I), of:

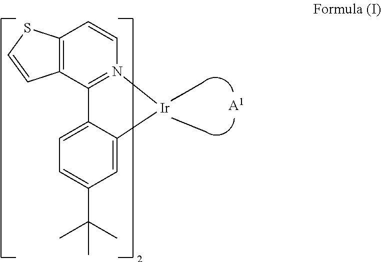

wherein, A¹ is diisopropyl carbodiimide ligand, 5-(2-pyridyl)-1,2,4-triazole ligand, acetylacetone with phenyl group ligand, 2-phenyl-1,3,4-oxadiazole ligand, or derivatives thereof.

In another exemplary embodiment of the disclosure, an organic electroluminescent device is provided. The device includes a pair of electrodes and an electroluminescent element disposed between the pair of electrodes, wherein the electroluminescent element includes the aforementioned organometallic compound (serving as a reddish orange or red dopant).

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a cross section of an organic electroluminescent device disclosed by an embodiment of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides an organometallic compound prepared by introducing a 4-phenylthieno[3,2-c]pyridine, such that an obtained organometallic compound would be suitable for use in a wet process or evaporation process. Moreover, the organometallic compound of the disclosure can be applied in an organic electroluminescent device for enhancing the electroluminescent efficiency thereof.

Organometallic Compound

The disclosure provides an organometallic compound having a structure represented by Formula (I):

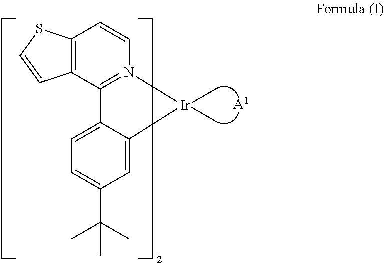

wherein, A¹ is diisopropyl carbodiimide ligand, 5-(2-pyridyl)-1,2,4-triazole ligand, acetylacetone with phenyl group ligand, 2-phenyl-1,3,4-oxadiazole ligand, or derivatives thereof.

According to an embodiment of the disclosure, A¹ is bonded with Ir via a nitrogen atom on one side, and bonded with Ir via another nitrogen atom on the other side. Further, A¹ is bonded with Ir via an oxygen atom on one side, and bonded with Ir via another oxygen atom on the other side. Moreover, A¹ can be bonded with Ir via a carbon atom on one side, and bonded with Ir via a nitrogen atom on the other side.

According to some embodiments of the disclosure, the organometallic compound of the disclosure can have a structure represented by Formula (II), or Formula (III), of:

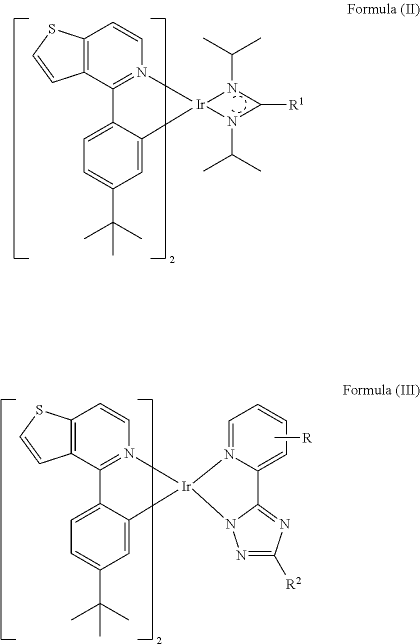

wherein, R¹ is hydrogen, phenyl, or biphenyl; and R² is hydrogen, fluoromethyl, or fluoroethyl; and R is hydrogen, or C₁₋₈ alkyl group.

Further, the organometallic compound has a Formula (IV), of:

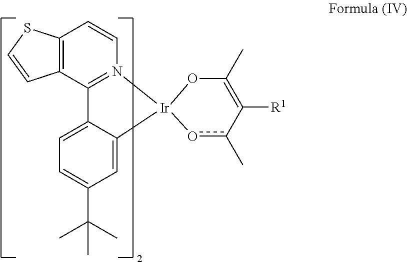

wherein, R¹ is hydrogen, phenyl, or biphenyl.

Moreover, the organometallic compound has a Formula (V), of:

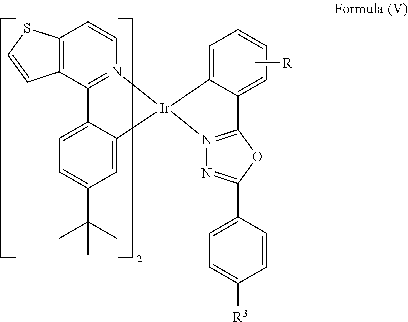

wherein R³ is hydrogen, methyl, ethyl, propyl, or iso-propyl group; and R is hydrogen, or C₁₋₈ alkyl group.

The organometallic compounds according to Formula (I) and Formula (II) of the disclosure include the following compounds shown in Table 1. In addition, the contraction thereof are also named and shown in Table 1.

TABLE 1

| Example | structure | contraction |
|---|---|---|
| 1 | 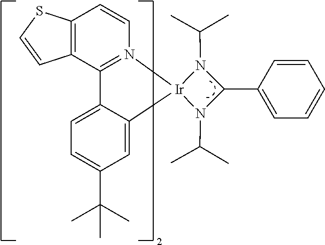 | PO-01-TB-dipba |
| 2 | 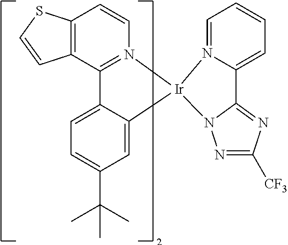 | PO-01-TB-fptz |
| 3 | 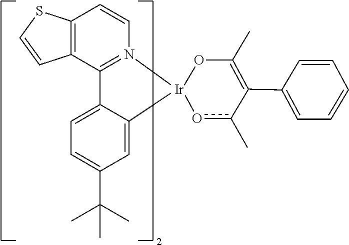 | PO-01-TB-phac |
| 4 | 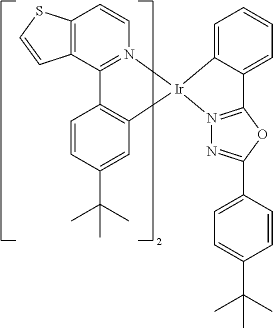 | PO-01-TB-0da |

In order to clearly illustrate the method for preparing organometallic compounds according to Formula (I), the preparation of compounds disclosed in Examples 1-4 are described in detail as below.

### EXAMPLE 1

Preparation of Compound PO-01-TB-dipba

First, compound (1) (2-(2-aminoethyl)thiophene, 7.0 g, 55.1 mmol) and 200 mL H2O were added into a 500 mL bottle. Next, compound (2) (4-t-butyl benzoyl chloride, 16.2 g, 82.5 mmol, 1.16 eq.) was added dropwisely into the bottle under ice-bath cooling. After, the NaOH aqueous solution (20%) was added into the bottle and stirred overnight. After filtration, a compound (3) (15.4 g, 98%) as a white solid was obtained. The synthesis pathway was as follows:

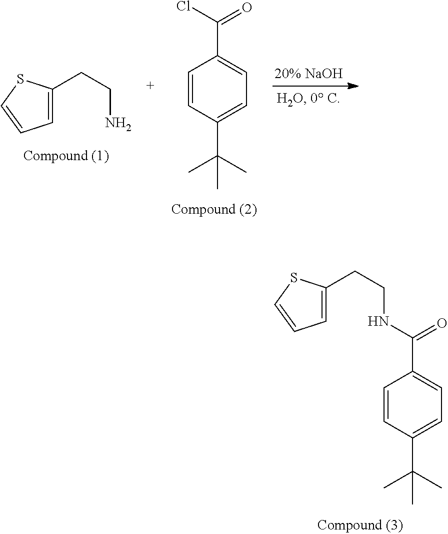 [SMILES: NCCc1cccs1 ; CC(C)(C)c1ccc(C(=O)Cl)cc1 ; CC(C)(C)c1ccc(C(=O)NCCc2cccs2)cc1]

The physical measurements of the compound (3) are listed below::

1H NMR (CDCl3, 200 MHz) δ 7.67(d, J=8.4 Hz, 2H), 7.43(d, J=8.4 Hz, 2H), 7.20(d, J=3.2 Hz, 1H), 6.97(q, J=8.0, 3.6 Hz, 1H), 6.88(d, J=3.2 Hz, 1H), 6.24(s, 1H), 7.73(q, J=6.2 Hz, 2H), 3.15(t, J=6.2 Hz, 2H), 1.34(s, 9H).

Compound (3) (2.87 g, 10 mmol) and toluene (80 mL) were added into a 250 mL bottle. Next, POCl₃ (2.8 mL, 30 mmol, 3 eq.) was added dropwisely into the bottle under ice-bath cooling. After, the mixture was heated to reflux. After stirring and refluxing for 2 hrs, a saturated NaHCO3 aqueous solution was added into the reaction bottle for quenching of the reaction. After toluene extraction, an organic layer was collected and dried by magnesium sulfate. After concentration, a compound (4) (crystal) was obtained with a yield of 80%. The synthesis pathway of the above reaction was as follows:

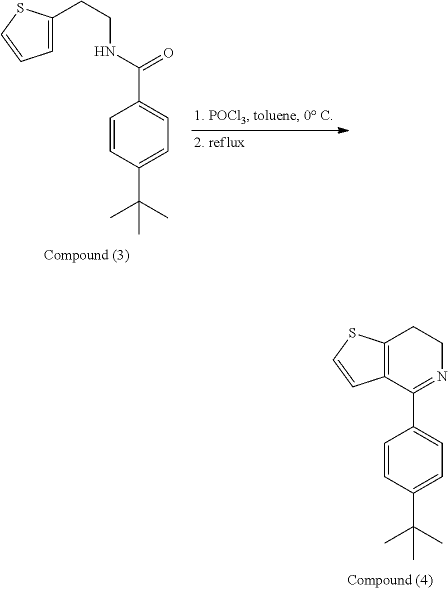 [SMILES: CC(C)(C)c1ccc(C(=O)NCCc2cccs2)cc1 ; CC(C)(C)c1ccc(C2=NCCc3sccc32)cc1]

The physical measurements of the compound (4) are listed below::

¹H NMR (CDCl3, 200 MHz) δ 7.96(d, J=8.4 Hz, 2H), 7.64(d, J=8.4 Hz, 2H), 7.38(d, J=5.6 Hz, 1H), 7.27(d, J=5.8 Hz, 1H), 3.95(t, J=8.0 Hz, 2H), 3.32(t, J=8.0 Hz, 2H), 1.36(s, 9H).

Compound (4) (2.7 g, 10 mmol), toluene (100 mL) and 10% Pd/C (0.5 g) were added into a 500 mL bottle and heated to reflux. After stirring for 18 hrs, the result was filtrated by Celite 545 to remove Pd/C. After concentrating the filtrate, a compound (5) was obtained with a yield of 795%. The synthesis pathway of the above reaction was as follows:

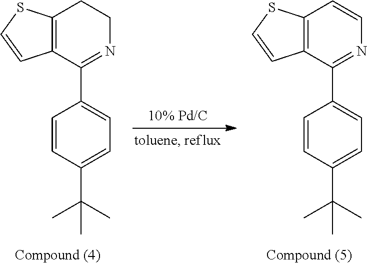 [SMILES: CC(C)(C)c1ccc(C2=NCCc3sccc32)cc1 ; CC(C)(C)c1ccc(-c2nccc3sccc23)cc1]

The physical measurements of the compound (5) are listed below::

¹H NMR (CDCl3, 200 MHz) δ 8.54(d, J=5.4 Hz, 1H), 7.81(s, 1H), 7.76(t, J=2.6 Hz, 2H), 7.67(d, J=5.4 Hz, 1H), 7.55(d, J=6.6 Hz, 2H), 7.48(d, J=5.8 Hz, 1H), 1.39(s, 9H).

Compound (5) (5.0 g, 18.7 mmol, 2.2 eq.), IrCl3.xH2O (2.9 g, 8.5 mmol), 2-methoxy ethanol (15 mL), and water (5 mL) were added into a 100 mL bottle. After heating to 140° C. for 24 hrs, the reaction was quenched by water. After filtration, a compound (6) (orange solid) was obtained with a yield of 49%. The synthesis pathway of the above reaction was as follows:

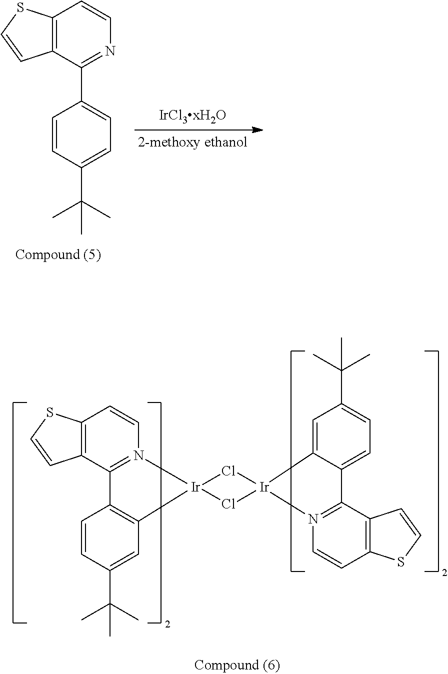

The physical measurements of the compound (6) are listed below::

¹H NMR (CDCl₃, 200 MHz) δ 9.29(d, J=6.4 Hz, 4H), 8.31(d, J=4.6 Hz, 4H), 7.96(d, J=8.4 Hz, 4H), 7.69(d, J=5.4 Hz, 4H), 7.03(d, J=6.6 Hz, 4H), 6.83(dd, J=8.2, 1.4 Hz, 1H), 5.92(d, J=2.2 Hz, 1H), 0.84(s, 36H).

Next, compound (7)(Bromobenzene, 0.94 mL, 8.96 mmol) and THF (30 mL) were added into a 250 mL bottle. After cooling to −78° C., n-BuLi (5.6 mL, 8.96 mmol) was slowly added into the bottle. After stirring for 1 hr, N,N-diisopropylcarbodiimide (1.4 mL, 8.96 mmol) was added into the bottle. After reacting at room temperature for 2 hrs, a solution containing compound (8) was obtained. Next, the solution containing compound (8) was mixed with compound (6) (3.4 g, 2.24 mmol) dissolved in THF (50 mL), and the mixture was heated to reflux. After stirring and refluxing overnight, the result was filtrated and washed with diethyl ether, obtaining a compound PO-01-TB-dipba with a yield of 65%). The synthesis pathway was as follows:

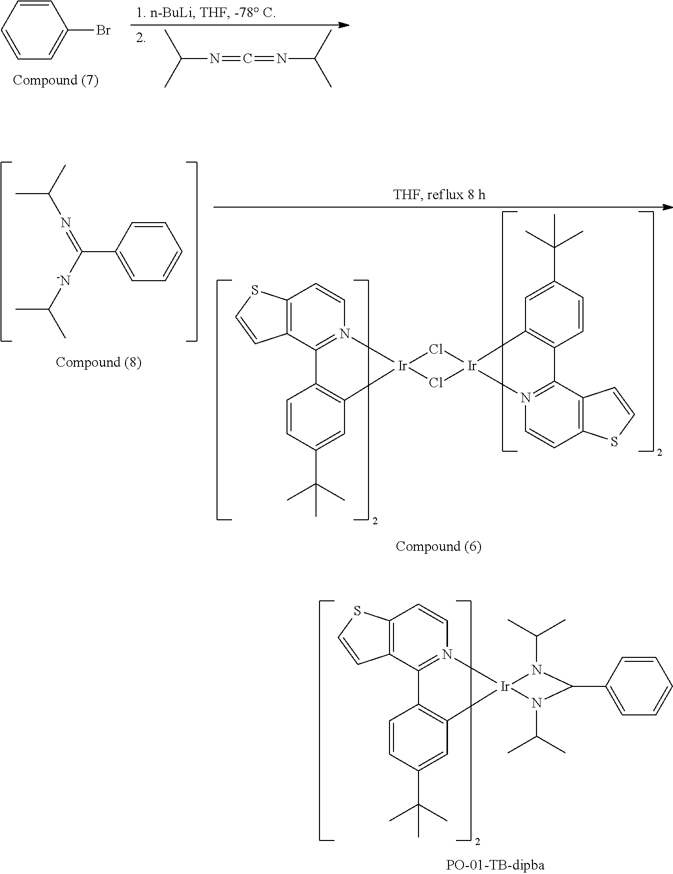

The physical measurements of the compound PO-01-TB-dipba are listed below:

¹H NMR (200 MHz, CDCl₃) δ 9.38(d, J=6.6 Hz, 2H), 8.27(d, J=5.4 Hz, 2H), 7.96(d, J=8.4 Hz, 2H), 7.75(d, J=6.6 Hz, 2H), 7.62(d, J=5.6 Hz, 2H), 7.28˜7.42(m, 10H), 6.82(dd, J=8.0, 1.8 Hz, 2H), 6.28(d, J=1.8 Hz, 2H), 3.25(m, 2H), 0.94(s, 18H), 0.66(d, J=6.2 Hz, 6H), −0.09(d, J=6.2 Hz, 6H).

### EXAMPLE 2

Preparation of Compound PO-01-TB-fptz

Compound (6) (5.0 g, 3.29 mmol), compound (9)(2.80 g, 13.17 mmol, 4 eq.), Na2CO3(1.40 g, 13.17 mmol, 4 eq.), and 2-methoxyethanol (30 mL) were added into a 250 mL bottle and heated to 140° C. for 24 hrs. After cooling, the result was washed with water and purified by column chromatography with n-hexane/ethyl acetate (3:1), obtaining a compound PO-01-TB-fptz with a yield of 40%. The synthesis pathway was as follows:

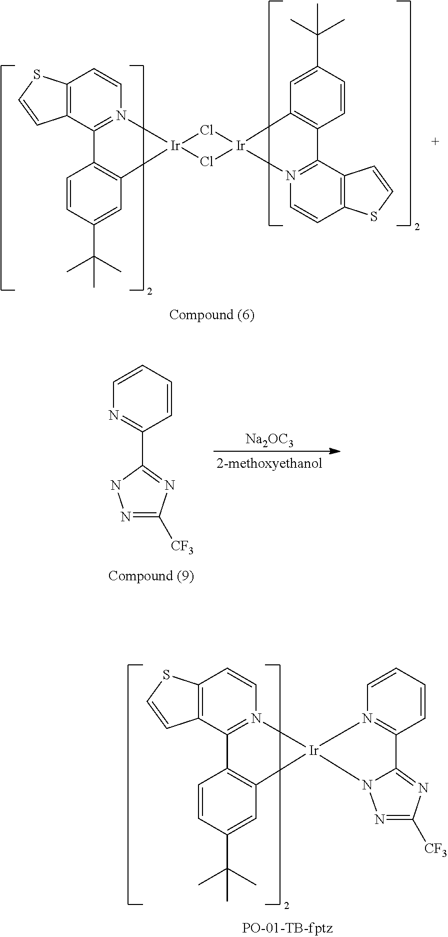

The physical measurements of the compound PO-01-TB-fptz are listed below:

¹H NMR (200 MHz, CDCl₃) δ 8.29(d, J=6.6 Hz, 2H), 8.08(d, J=5.4 Hz, 2H), 7.65(d, J=8.4 Hz, 2H), 7.42˜7.64(m, 4H), 7.36(d, J=6.6 Hz, 2H), 7.06(d, J=5.4 Hz, 2H), 6.32(d, J=2.0 Hz, 2H), 0.96(s, 18H).

### EXAMPLE 3

Preparation of Compound PO-01-TB-phac

Compound (6) (5.0 g, 3.29 mmol), compound (10) (3-phenyl-2,5-pentanedione, 1.73 g, 9.87 mmol, 3 eq.), Na2CO3(3.49 g, 32.92 mmol, 10 eq.), and 2-methoxyethanol (30 mL) were added into a 250 mL bottle and heated to 140° C. for 24 hrs. After cooling, the result was washed with water and purified by column chromatography with n-hexane/ethyl acetate (3:1), obtaining a compound PO-01-TB-phac with a yield of 53%. The synthesis pathway was as follows:

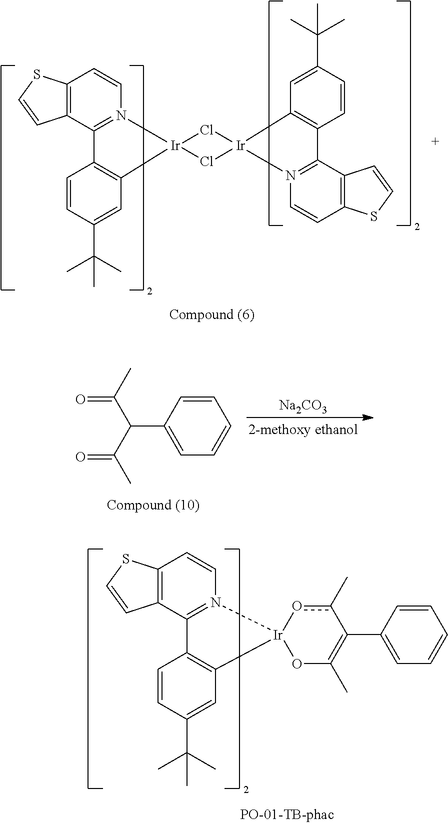

The physical measurements of the compound PO-01-TB-phac are listed below:

¹H NMR (200 MHz, CDCl₃) δ 8.60(d, J=6.6 Hz, 2H), 8.32(d, J=5.4 Hz, 2H), 8.02(d, J=8.4 Hz, 2H), 7.66˜7.74(m, 5H), 7.27(d, J=6.6 Hz, 2H), 7.14(d, J=1.8 Hz, 2H), 6.93(d, J=1.8 Hz, 2H), 6.24(d, J=2.0 Hz, 2H), 1.61(s, 6H), 0.98(s, 18H).

### EXAMPLE 4

Preparation of Compound PO-01-TB-oda

Compound (6) (5.0 g, 3.29 mmol), compound (11) (3.66 g, 13.17 mmol, 4 eq.), Na₂CO₃ compound (1)1 (3.66 g, 13.17 mmol, 4 eq.), and 2-methoxyethanol (35 mL) were added into a 250 mL bottle and heated to 140° C. for 24 hrs. After cooling, the result was washed with water and purified by column chromatography with n-hexane/ethyl acetate (3:1), obtaining a compound PO-01-TB-oda with a yield of 30%. The synthesis pathway was as follows:

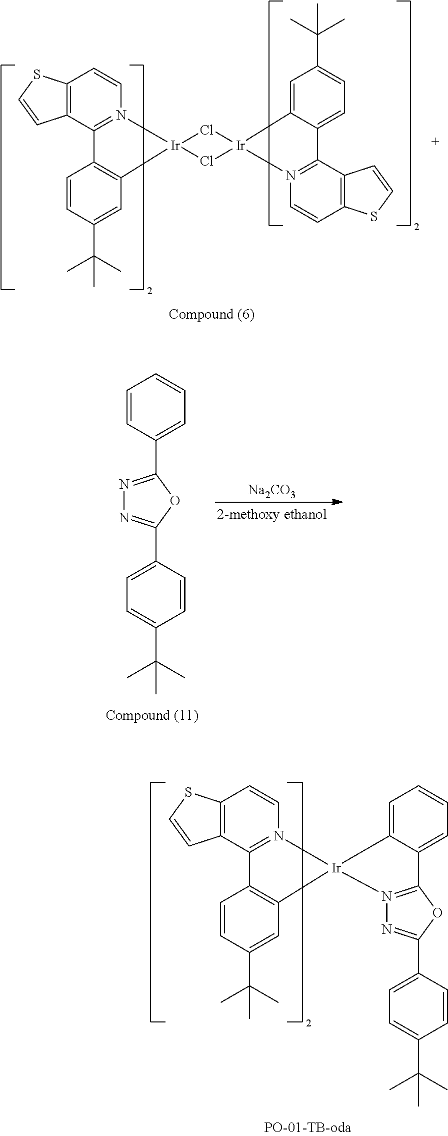

The physical measurements of the compound PO-01-TB-oda are listed below:

1H NMR (200 MHz, CDCl3) δ 8.60(d, J=6.8 Hz, 2H), 8.32(d, J=5.2 Hz, 2H), 8.12˜8.16(m, 2H), 8.02˜8.09(m, 2H), 7.53˜7.57(m, 5H), 7.28(d, J=6.6 Hz, 2H), 7.14(d, J=1.6 Hz, 2H), 6.94(d, J=1.8 Hz, 2H), 6.24(d, J=1.8 Hz, 2H), 1.37(s, 9H), 0.98(s, 18H).

Organic Electroluminescent Device

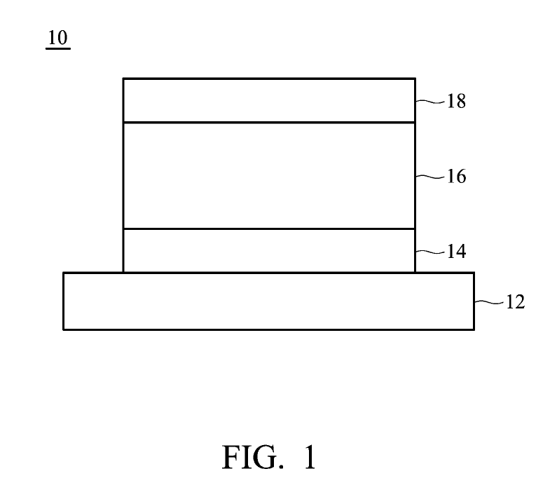

FIG. 1 shows an embodiment of an organic electroluminescent device 10. The electroluminescent device 100 includes a substrate 12, a bottom electrode 14, an electroluminescent element 16, and a top electrode 18, as shown in FIG. 1. The organic electroluminescent device can be top-emission, bottom-emission, or dual-emission devices.

The substrate 12 can be a glass plastic, or semiconductor substrate. Suitable materials for the bottom and top electrodes can be Ca, Ag, Mg, Al, Li, In, Au, Ni, W, Pt, Cu, indium tin oxide (ITO), indium zinc oxide (IZO), aluminum zinc oxide (AZO), or zinc oxide (ZnO), formed by sputtering, electron beam evaporation, thermal evaporation, or chemical vapor deposition. Further, at least one of the bottom and top electrodes 14 and 18 is transparent.

The electroluminescent element 16 at least includes an emission layer, and can further include a hole injection layer, a hole transport layer, an electron transport layer, and an electron injection layer. In an embodiment of the disclosure, at least one layer of the electroluminescent element 16 includes the aforementioned organometallic compound.

According to an embodiment of the disclosure, the organic electroluminescent device can be a phosphorescent organic electroluminescent device, and the phosphorescent organic electroluminescent device can include an emission layer including a host material and a phosphorescent dopant, wherein the host material includes the aforementioned organometallic compounds.

In order to clearly disclose the organic electroluminescent devices of the disclosure, the following examples (employing the organometallic compounds of Example 1 serving as dopant) are intended to illustrate the disclosure more fully without limiting their scope, since numerous modifications and variations will be apparent to those skilled in this art.

### EXAMPLE 5

A glass substrate with an indium tin oxide (ITO) film of 100 nm was provided and then washed with a cleaning agent, acetone, and isopropanol with ultrasonic agitation. After drying with a nitrogen flow, the ITO film was subjected to a UV/ozone treatment. Next, NPB(N,N′-di(naphthalene-1-yl)-N,N′-diphenyl-benzidine, with a thickness of 40 nm), CBP(4,4′-N,N′-dicarbazole-biphenyl)doped with PO-01-TB-dipba

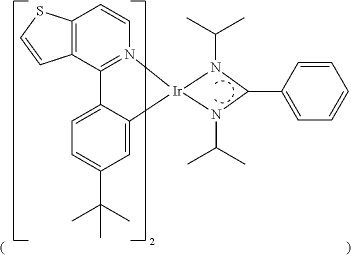

(the ratio between CBP and PO-01-TB-dipba was 100:6, with a thickness of 30 nm), BCP (2,9-dimethyl-4,7diphenyl-1,10-phenanthroline, with a thickness of 10 nm), Alq(tris(8-hydroxyquinoline)aluminum, with a thickness of 20 nm), LiF (with a thickness of 0.5 nm), and Al (with a thickness of 120 nm) were subsequently formed on the ITO film at 10⁻⁶ Pa, obtaining the electroluminescent device (1). The materials and layers formed therefrom are described in the following:

NPB(40 nm)/CBP: PO-01-TB-dipba(6%) (30 nm)/BCP(10 nm)/Alq(20 nm)/LiF(0.5 nm)/Al(120 nm)

The optical property of the electroluminescent device (1), as described in Example 5, was measured by a PR650 (purchased from Photo Research Inc.) and a Minolta TS110. The results are shown below:

Emissive efficiency: 39.9 cd/A@1495.4 cd/m2@7.5V;

Driving voltage: 5.5-6.0V;

Electroluminescent wavelength: 592-596 nm;

CIE coordinations: (0.59,0.41).

### EXAMPLE 6

A glass substrate with an indium tin oxide (ITO) film of 100 nm was provided and then washed with a cleaning agent, acetone, and isopropanol with ultrasonic agitation. After drying with a nitrogen flow, the ITO film was subjected to a UV/ozone treatment. Next, NPB(N,N′-di(naphthalene-1-yl)-N,N′-diphenyl-benzidine, with a thickness of 40 nm), CBP(4,4′-N,N′-dicarbazole-biphenyl)doped with PO-01-TB-dipba

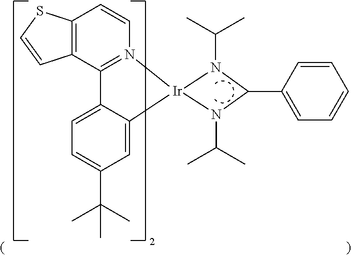

(the ratio between CBP and PO-01-TB-dipba was 100:5, with a thickness of 30 nm), BCP (2,9-dimethyl-4,7diphenyl-1,10-phenanthroline, with a thickness of 10 nm), Alq(tris (8-hydroxyquinoline)aluminum, with a thickness of 20 nm), LiF (with a thickness of 0.5 nm), and Al (with a thickness of 120 nm) were subsequently formed on the ITO film at 10⁻⁶ Pa, obtaining the electroluminescent device (2). The materials and layers formed therefrom are described in the following:

NPB(40 nm)/CBP: PO-01-TB-dipba (5%)(30 nm)/BCP(10 nm)/Alq(20 nm)/LiF(0.5 nm)/Al(120 nm)

The optical property of the electroluminescent device (2), as described in Example 6, was measured by a PR650 (purchased from Photo Research Inc.) and a Minolta TS110. The results are shown below:

Optimal efficiency: 45.3 cd/A, 25.9 lm/W;

Emissive efficiency: 38.7 cd/A, 15.01 m/W@1000 cd/m²

Electroluminescent wavelength: 592 nm;

CIE coordinations: (0.59,0.41)

### EXAMPLE 7

A glass substrate with an indium tin oxide (ITO) film of 100 nm was provided and then washed with a cleaning agent, acetone, and isopropanol with ultrasonic agitation. After drying with a nitrogen flow, the ITO film was subjected to a UV/ozone treatment. Next, NPB(N,N′-di(naphthalene-1-yl)-N,N′-diphenyl-benzidine, with a thickness of 40 nm), Balq (aluminium(III)bis(2-methyl-8-quninolinato)-4-phenylphenolate) doped with PO-01-TB-dipba

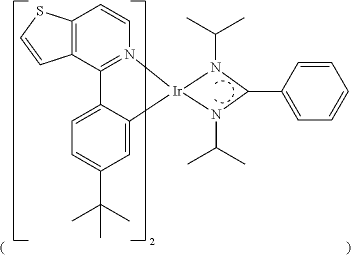

(the ratio between Balq and PO-01-TB-dipba was 100:4, with a thickness of 30 nm), BCP (2,9-dimethyl-4,7diphenyl-1,10-phenanthroline, with a thickness of 10 nm), Alq(tris(8-hydroxyquinoline)aluminum, with a thickness of 20 nm), LiF (with a thickness of 0.5 nm), and Al (with a thickness of 120 nm) were subsequently formed on the ITO film at 10⁻⁶ Pa, obtaining the electroluminescent device (3). The materials and layers formed therefrom are described in the following:

NPB(40 nm)/Balq: PO-01-TB-dipba (4%)(30 nm)/BCP(10 nm)/Alq(20 nm)/LiF(0.5 nm)/Al(120 nm)

The optical property of the electroluminescent device (3), as described in Example 7, was measured by a PR650 (purchased from Photo Research Inc.) and a Minolta TS110. The results are shown below:

Optimal efficiency: 27.9 cd/A, 14.6 lm/W;

Emissive efficiency: 24.6 cd/A, 11.1 lm/W@1000 cd/m²;

Electroluminescent wavelength: 600 nm;

CIE coordinations: (0.61,0.39).

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An organometallic compound having a Formula (I), of: 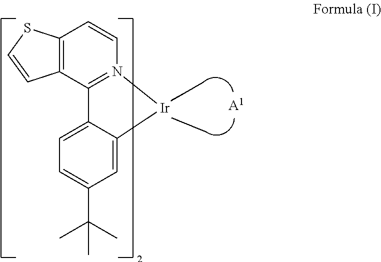
wherein, A¹ is diisopropyl carbodiimide ligand, 5-(2-pyridyl)-1,2,4-triazole ligand, acetylacetone with phenyl group ligand, 2-phenyl-1,3,4-oxadiazole ligand, or derivatives thereof.

2. The organometallic compound as claimed in claim 1, wherein A¹ is bonded with Ir via a nitrogen atom on one side, and bonded with Ir via another nitrogen atom on the other side.

3. The organometallic compound as claimed in claim 2, wherein the organometallic compound has a Formula (II) or Formula (III), of: 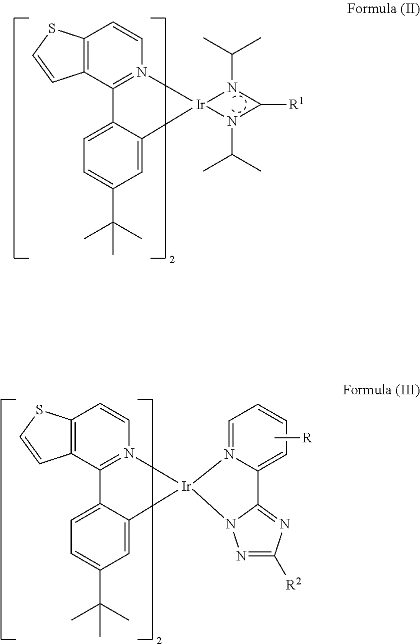
wherein R¹ is hydrogen, phenyl, or biphenyl; R² is hydrogen, fluoromethyl, or fluoroethyl; and R is hydrogen, or C₁₋₈ alkyl group.

4. The organometallic compound as claimed in claim 3, wherein the organometallic compound comprises

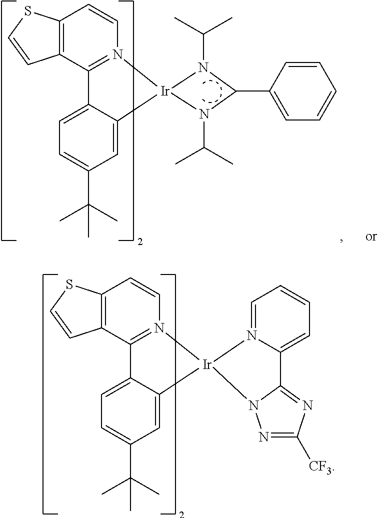

5. The organometallic compound as claimed in claim 1, wherein A¹ is bonded with Ir via an oxygen atom on one side, and bonded with Ir via another oxygen atom on the other side.

6. The organometallic compound as claimed in claim 5, wherein the organometallic compound has a Formula (IV), of: 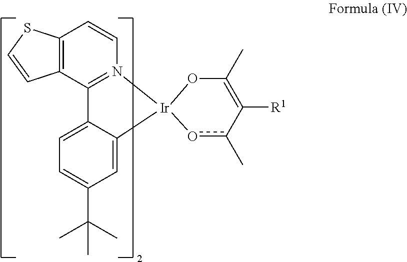
wherein, R¹ is hydrogen, phenyl, or biphenyl.

7. The organometallic compound as claimed in claim 6, wherein the organometallic compound comprises

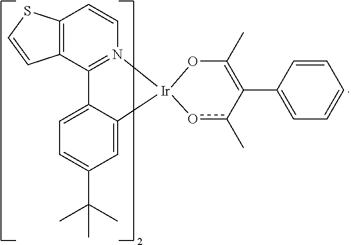

8. The organometallic compound as claimed in claim 1, wherein A¹ is bonded with Ir via a carbon atom on one side, and bonded with Ir via a nitrogen atom on the other side.

9. The organometallic compound as claimed in claim 8, wherein the organometallic compound has a Formula (V), of: 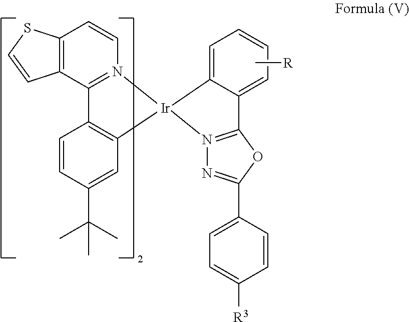
wherein R³ is hydrogen, methyl, ethyl, propyl, or iso-propyl group; and R is hydrogen, or C₁₋₈ alkyl group.

10. The organometallic compound as claimed in claim 9, wherein the organometallic compound comprises

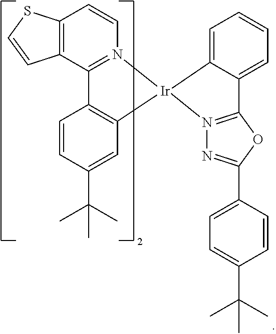

11. An organic electroluminescence device, comprising:
a pair of electrodes; and
an electroluminescent element disposed between the pair of electrodes, wherein the electroluminescent element comprises the organometallic compound as claimed in claim 1.

12. The organic electroluminescence device as claimed in claim 11, wherein the electroluminescent element emits reddish orange or red light under a bias voltage.
